(19) United States
(12) Patent Application Publication
(10) Pub. No.: US 2005/0205683 A1
(43) Pub. Date: Sep. 22, 2005

(54) Cooling circuit for an internal combustion engine

(76) Inventors: Manfred Schmitt, Heppenheim (DE); Karsten Mann, Stuttgart (DE); Oliver Kaefer, Murr (DE); Herbert Windisch, Bad Friedrichshall (DE)

Correspondence Address: KENYON & KENYON, ONE BROADWAY, NEW YORK, NY, 10004, US

(21) Appl. No.: 10/507,038

(22) PCT Filed: Feb. 18, 2003
(86) PCT No.: PCT/DE03/00487

§ 371 Date: May 23, 2005

(30) Foreign Application Priority Data
Mar. 8, 2002 (DE) 102 10 303.8

(51) Int. Cl. B60H 1/02

(52) U.S. Cl. 237/12

(57) ABSTRACT

A cooling circuit for an internal combustion engine includes a first coolant circuit and a second coolant circuit, the cooling circuit being able to be operated by a distributor so that the internal combustion engine reaches its operating temperature as quickly as possible, and a heat exchanger used to heat the vehicle interior is operational as quickly as possible. The return channel from the second coolant circuit is connectable to either the return channel or the flow channel of the first coolant circuit.

### FIELD OF THE INVENTION

The present invention relates to a cooling circuit for an internal combustion engine.

### BACKGROUND INFORMATION

A water-cooled internal combustion engine of a motor vehicle is cooled by a coolant, usually water including various additives, which is circulated through the engine block and the cylinder head of the internal combustion engine by a main coolant pump. From the cylinder head, the coolant reaches a radiator or, alternatively, a heat exchanger. A cooling circuit for an internal combustion engine, which allows the cooling capacity in different areas of the engine to be adjusted to the actual cooling requirements, is described in Published German Patent document DE 199 38 614.

A known cooling circuit is first described below in connection with FIG. 3, and its disadvantages are explained. FIG. 3 shows a schematic representation of a water-cooled internal combustion engine 1. Internal combustion engine 1 includes a cylinder head 3 and an engine block 5, both of which are cooled by a water cooling jacket that is not illustrated. Internal combustion engine 1 is cooled by a first coolant circuit 7, which includes a first flow channel 9, a radiator 11, and a first return channel 13. Installed in first coolant circuit 7 is a thermostat-controlled mixer 15, which, as a function of the temperature of first flow channel 9, controls a bypass 17, which interconnects first flow channel 9 and first return channel 13 while circumventing radiator 11. The thermostat for controlling the mixer 15 is not illustrated in FIG. 3, since thermostats of this type are adequately known in the art. A main coolant pump 19, which conducts coolant to engine block 5 of internal combustion engine 1, is installed in first return channel 13.

The section of first flow channel 9 located between mixer 15 and radiator 11, as well as the section of first return channel 13 located between radiator 11 and bypass line 17, are represented by dotted lines in FIG. 3 to indicate that mixer 15 has fully opened bypass line 17 and prevents coolant from flowing through radiator 11. Mixer 15 assumes this position when the temperature of flow channel 9 is still low, i.e., when internal combustion engine 1 is still in the cold start phase.

A heat exchanger 23 is supplied with waste heat from cylinder head 3 as needed via a second coolant circuit 21. Second coolant circuit 21 includes a second flow channel 25, a second return channel 27, and a second bypass line 29. The output of heat exchanger 23 may be regulated via a second mixer 31. This output regulation is known in the art and is therefore not described in further detail.

An auxiliary coolant pump 33 is located in second return channel 27. Auxiliary coolant pump 33 is used, according to the known art, to increase the volume flowing through the heating circuit and thus to boost the heating capacity, especially at low engine speeds. A thermostat 35, which measures the temperature in second flow channel 25, regulates the flow of cooling water through a wiper fluid heater.

As mentioned above, internal combustion engine 1 is still in the cold start phase, since first bypass line 17 is fully open and coolant is not yet flowing through radiator 11. The directions of coolant flow in first flow channel 9, first return channel 13, second flow channel 25, second return channel 27, first bypass line 17, and second bypass line 29 are illustrated by arrows in FIG. 3. This representation shows that heat is exchanged between engine block 5 and cylinder head 3 within the internal combustion engine, due to the thermosiphon effect. As a result of this internal heat exchange, engine block 5 reaches its operating temperature only at a slow rate, which is undesirable.

### SUMMARY OF THE INVENTION

The present invention provides a cooling circuit for an internal combustion engine that enables the internal combustion engine to be brought to operating temperature as quickly as possible after startup, without the danger of local overheating. In addition, the cooling circuit according to the present invention allows heat to be supplied very quickly to the heat exchanger, via which heat is supplied to the vehicle interior. To accomplish this, the return channel from the second coolant circuit, which supplies coolant to the heat exchanger, is connectable to either the return channel or the flow channel of the first coolant circuit, which discharges waste heat from the internal combustion engine via the radiator. Connecting the second return channel of the second coolant circuit to the first flow channel of the first coolant circuit, while simultaneously taking the second return channel out of service, produces a small cooling circuit that flows through only the cylinder head of the internal combustion engine, thus preventing the cylinder head from overheating and allowing the engine block of the internal combustion engine to reach its operating temperature as quickly as possible.

In a first embodiment of the cooling circuit according to the present invention, a main coolant pump is provided in the first coolant circuit, and an auxiliary coolant pump is provided in the second coolant circuit, so that, if necessary, the discharge of heat from the internal combustion engine is adjustable to the necessary requirements.

According to further example embodiment of the present invention, a bypass line for circumventing the radiator is provided in the first coolant circuit, it being advantageous to open or close the bypass line in a temperature-controlled manner so that the temperature of the internal combustion engine may be maintained at a constant level largely independent of the ambient conditions and the internal load of the internal combustion engine.

To ensure more comfortable heating of the vehicle interior, the auxiliary coolant pump may be regulated or controlled in a temperature-controlled manner.

Optimum performance of the cooling circuit may be achieved by operating the cooling circuit according to the following procedure:
Detection of the temperature of the internal combustion engine.
Deactivation of the main coolant pump and the auxiliary coolant pump; setting of the distributor to its first position if the temperature of the internal combustion engine is less than a first threshold value.
Deactivation of the main coolant pump and activation of the auxiliary coolant pump; setting of the distributor to its first position if the temperature of the internal combustion engine is greater than or equal to the first threshold value and less than a second threshold value.
Activation of the main coolant pump and deactivation of the auxiliary coolant pump; setting of the distributor to its second position if the temperature of the internal combustion engine is greater than or equal to the second threshold value.

Operating the cooling circuit of the present invention according to the above procedure ensures that the internal combustion engine reaches its operating temperature as quickly as possible, the heat exchanger is supplied with heat as soon as possible and, upon reaching the operating temperature, the internal combustion engine is adequately cooled to avoid overheating in all operating states.

To prevent local overheating during the cold start phase of the internal combustion engine, one may activate the main coolant pump, deactivate the auxiliary coolant pump and set the distributor to its second position if the power output of the internal combustion engine exceeds a preset limit value. The power output of the internal combustion engine may be calculated, for example, on the basis of the product of the rotational speed of the internal combustion engine and the torque output by the internal combustion engine. Alternatively, either the torque or the rotational speed alone may be used as the criterion for activating the main coolant pump.

As a further security measure, the main coolant pump is activated, at the latest, upon reaching a maximum pump deactivation time, which may be determined as a function of the engine temperature when starting the internal combustion engine.

### BRIEF DESCRIPTION OF THE DRAWINGS

FIG. 1 shows an exemplary embodiment of a cooling circuit according to the present invention in a first operating state.

FIG. 2 shows an exemplary embodiment of a cooling circuit according to the present invention in a second operating state.

FIG. 3 shows a prior art cooling circuit.

FIG. 4 shows a flow chart of a method for the optimum operation of the cooling circuit according to the present invention.

### DETAILED DESCRIPTION

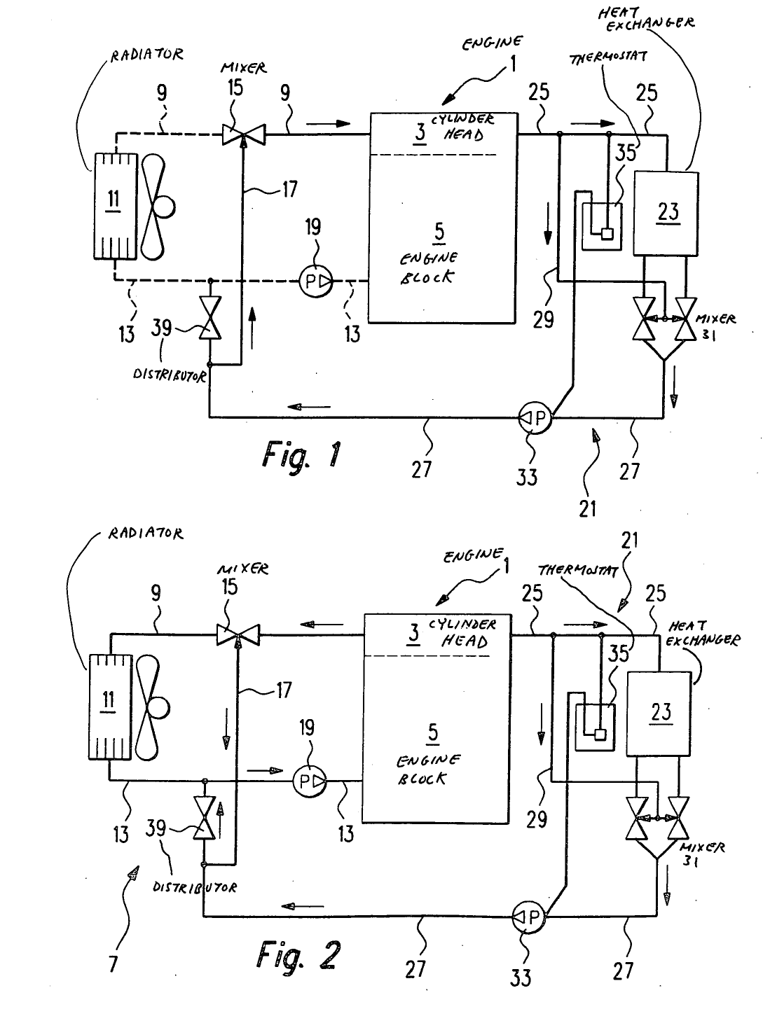

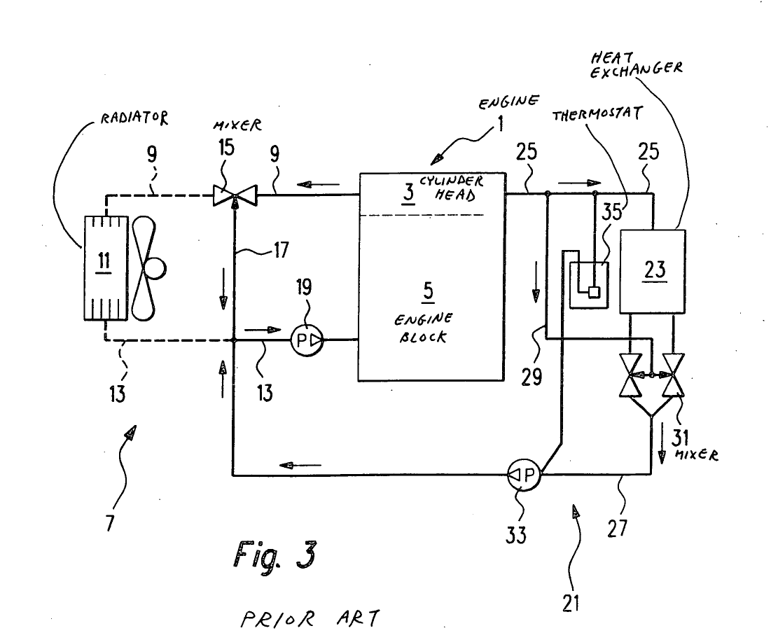

FIG. 1 shows an exemplary embodiment of a cooling circuit according to the present invention in which this undesirable internal heat exchange does not take place within internal combustion engine 1. The same components are identified by the same reference numbers as in FIG. 3, and the remarks made in reference to FIG. 3 also apply accordingly to FIG. 1. In addition to the components shown in FIG. 3, the cooling circuit according to the present invention also includes a distributor 39. The position of distributor 39 shown in FIG. 1 establishes a hydraulic connection between second return channel 27 and first flow channel 9 via first bypass line 17. Main coolant pump 19 is deactivated, preventing coolant from flowing through radiator 11. In this position, the coolant flows from second channel 27 to cylinder head 3 via first bypass line 17 and first flow channel 9. The coolant is discharged from cylinder head 3 into second flow channel 25, where it reaches second return channel 27 either via heat exchanger 23 or second bypass line 29. In this configuration of the cooling circuit according to the present invention, coolant does not flow through the engine block, which allows the engine to reach the operating temperature as quickly as possible.

However, cylinder head 3, which heats up faster than engine block 5, is adequately cooled to avoid impermissibly high operating temperatures in cylinder head 3. If necessary for thermal reasons, it is possible to also cool the upper area of the cylinders (not illustrated) in the internal combustion engine via cylinder head 3, since this area also belongs to the combustion chamber and therefore is subjected to rapid heating in the cold start phase. This configuration also ensures that hot coolant flows through heat exchanger 23 as quickly as possible so that the latter may discharge heat as quickly as possible.

If not only main coolant pump 19, but also auxiliary coolant pump 33, is deactivated at the beginning of a cold start, cylinder head 3 may reach its operating temperature in just a few seconds or minutes, causing the emissions of internal combustion engine 1 to drop very quickly after the cold start begins. A temperature sensor for measuring the component temperature at the internal combustion engine, e.g., in the area of cylinder head 3, makes it possible to prevent impermissible overheating of the cylinder head. Once cylinder head 3 has reached an adequate temperature, auxiliary coolant pump 33 may be activated, and the state illustrated in FIG. 1 occurs.

FIG. 2 shows the cooling circuit illustrated in FIG. 1, with distributor 39 assuming a position connecting second return channel 27 to first return channel 13. In FIG. 2, the directions of coolant flow are also indicated by arrows. In this state, main coolant pump 19 is activated so that engine block 5 is also cooled by coolant. Mixer 15 regulates the output of first coolant circuit 7 in the same manner as shown in FIG. 3. The output of heat exchanger 23 is also regulated as shown in FIG. 3.

The cooling circuit according to the present invention enables an internal combustion engine to reach its operating temperature as quickly as possible without resulting in disturbing internal heat convection. Different assemblies of internal combustion engine 1 may therefore reach their operating temperatures at different rates. For example, cylinder head 3 usually reaches its operating temperature before engine block 5. As soon as cylinder head 3 has reached an adequate temperature, heat may be discharged via second coolant circuit 21 and used to heat the vehicle interior via heat exchanger 23.

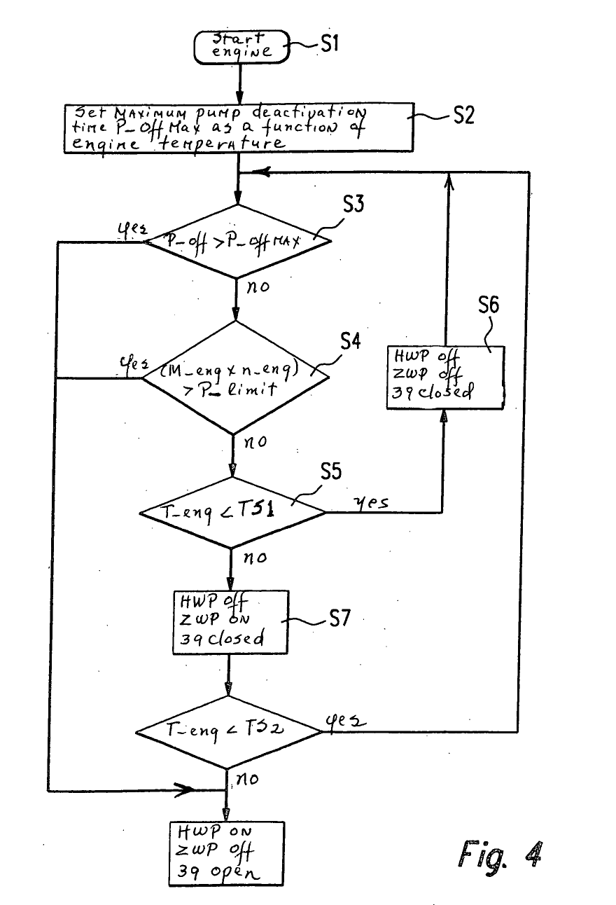

FIG. 4 shows a flow chart of a method for operating a cooling circuit according to the present invention. Internal combustion engine is started in a step S1. Immediately after the internal combustion engine starts, a maximum pump deactivation time P_{off, max} is set as a function of the engine temperature. This takes place in step S2. A third step S3 checks whether the main coolant pump (abbreviated as HWP) is deactivated for longer than maximum pump deactivation time P_{off, max}. If this is the case, main coolant pump HWP is activated. A fourth step S4 checks whether the power supplied to the internal combustion engine exceeds a limit value Pₗᵢₘᵢₜ, If this is the case, the main coolant pump is activated to avoid overheating the internal combustion engine. Otherwise, a step 5 checks whether temperature T_{eng} of the internal combustion engine is less than a first threshold value T_{S1}. If this is the case, main coolant pump HWP as well as the auxiliary coolant pump (abbreviated as ZWP) are deactivated, and distributor 39 is set to its position shown in FIG. 1. This procedure takes place in a step S6. The query then starts over again at step S3. If temperature T_{eng} of the internal combustion engine is greater than first threshold value T_{S1}, main coolant pump HWP remains deactivated, auxiliary coolant pump 33 is activated, and distributor 39 is closed. When distributor 39 is closed, this means that it has assumed its position shown in FIG. 1.

These operations take place in step S7. If temperature T_{eng} of the internal combustion engine is less than a second threshold value T_{S2} but greater than first threshold value T_{S1}, the sequence starts over again with third step S3. Otherwise, main coolant pump HWP is activated, auxiliary coolant pump ZWP is deactivated, and distributor 39 is opened, i.e., it assumes its position shown in FIG. 2 and connects first return channel 13 to second return channel 27.

Operating the cooling circuit of the present invention according to the method described in FIG. 4 provides maximum protection of the internal combustion engine against overheating, while simultaneously allowing it to reach its operating temperature as quickly as possible. The vehicle heating system may also be placed into service very quickly.

1-15. (canceled)

16. A cooling circuit for an internal combustion engine, comprising:
a first external coolant circuit including a first flow channel, a first return channel, and a main coolant pump, wherein the first external coolant circuit supplies waste heat from the internal combustion engine to a radiator, and wherein the first flow channel is connected to the cylinder head of the internal combustion engine;
a second external coolant circuit including a second flow channel, a second return channel, and an auxiliary coolant pump, wherein the second external coolant circuit supplies waste heat from the internal combustion engine to a heat exchanger, and wherein the second flow channel is connected to a cylinder head of the internal combustion engine; and
a distributor having a first position and a second position, wherein in the first position the distributor connects the first return channel to the second return channel, and wherein in the second position the distributor connects the second return channel to the first flow channel and the auxiliary coolant pump delivers coolant from the second return channel to the first flow channel, thereby bypassing an engine block of the internal combustion engine.

17. The cooling circuit as recited in claim 16, further comprising a bypass line provided in the first coolant circuit to bypass the radiator.

18. The cooling circuit as recited in claim 17, wherein the bypass line is selectively opened and closed depending on temperature.

19. The cooling circuit as recited in claim 17, wherein the distributor in the second position connects the second return channel to the first bypass line.

20. The cooling circuit as recited in claim 18, wherein the auxiliary coolant pump is controlled as a function of temperature.

21. A method for controlling a cooling circuit for an internal combustion engine, comprising:
detecting a temperature of the internal combustion engine;
deactivating a main coolant pump and an auxiliary coolant pump, and setting a distributor to a first position, when the temperature of the internal combustion engine is less than a first threshold value;
deactivating the main coolant pump and activating the auxiliary coolant pump, and setting the distributor to the first position, when the temperature of the internal combustion engine is at least equal to the first threshold value and less than a second threshold value; and
activating the main coolant pump and deactivating the auxiliary coolant pump, and setting the distributor to a second position, when the temperature of the internal combustion engine is at least equal to the second threshold value.

22. The method as recited in claim 21, wherein the main coolant pump is activated, the auxiliary coolant pump is deactivated, and the distributor is set to the first position, when a power output of the internal combustion engine exceeds a threshold limit value.

23. The method as recited in claim 22, wherein the power output of the internal combustion engine is calculated according to the following formula:
Power output=M_{eng}×n_{eng},
wherein M_{eng} is the torque output by the internal combustion engine, and n_{eng} is the rotational speed of the internal combustion engine

24. The method as recited in claim 21, wherein the main coolant pump is activated, the auxiliary coolant pump is deactivated, and the distributor is set to the first position, when one of a torque output of the internal combustion engine and a rotational speed of the internal combustion engine exceeds a threshold limit value.

25. The method as recited in claim 21, wherein the main coolant pump is activated, at the latest, after a predetermined maximum deactivation time has been exceeded.

26. The method as recited in claim 25, wherein the predetermined maximum deactivation time is dependent on a coolant temperature at the time the engine is started.

27. The method as recited in claim 21, wherein the auxiliary coolant pump is also activated as a function of the temperature in the second flow channel.

28. The method as recited in one of claim 21, wherein the auxiliary coolant pump is also activated as a function of a component temperature of the internal combustion engine.

29. The method as recited in claim 28, wherein the component temperature of the internal combustion engine is a temperature inside a cylinder head of the internal combustion engine.
